(19) United States
(12) Patent Application Publication
(10) Pub. No.: US 2025/0283320 A1
(43) Pub. Date: Sep. 11, 2025

(54) AUTOMATIC RETRACTABLE SCREEN DEVICE FOR STORM DRAINS HAVING CURBSIDE OPENINGS

(71) Applicant: Fabco Industries Inc., Hauppauge, NY (US)

(72) Inventor: John Peters, JR., Coram, NY (US)

(21) Appl. No.: 19/016,209

(22) Filed: Jan. 10, 2025

Related U.S. Application Data
(60) Provisional application No. 63/621,286, filed on Jan. 16, 2024.

(51) Int. Cl. E03F 5/14; B01D 29/05; B01D 35/02; C02F 1/00; C02F 103/00

(52) U.S. Cl. CPC E03F 5/14; B01D 29/05; B01D 35/02; C02F 1/001; B01D 2201/4069; C02F 2103/001

(57) ABSTRACT

An automatic retractable screen device is mountable within the interior cavity of a storm vault and adjacent to a vault opening formed in the side wall through which stormwater flows and into the interior cavity. The automatic retractable screen device includes a mounting assembly for mounting the automatic retractable screen device to the side wall of the storm vault, a pivotable screen positionable to be in alignment with the vault opening of the storm vault, structure affixed to the mounting assembly and the screen and configured to allow the screen to pivot on the mounting assembly between a closed position and an open position, and a magnetic release mechanism operatively coupled to the screen. The magnetic release mechanism holds the screen in the closed position to block debris carried by the stormwater from entering the vault opening until the force of the stormwater exerted on the screen exceeds a predetermined value at which point the screen is released to pivot to the open position.

### CROSS-REFERENCE TO RELATED APPLICATIONS

This application is related to U.S. Provisional Application Ser. No. 63/621,286, filed on Jan. 16, 2024, and titled “Automatic Retractable Screen Device For Storm Drains Having Curbside Openings”, the disclosure of which is incorporated herein by reference and on which priority is hereby claimed.

### BACKGROUND OF THE INVENTION

### Field of the Invention

The present invention generally relates to stormwater drainage systems, and more particularly relates to filtering apparatus used therewith. Even more specifically, the present invention relates to Automatic Retractable Screen (ARS) devices used in conjunction with storm drains formed with curbside openings.

### Description of the Prior Art

Stormwater drainage systems are commonly used in streets, highways, parking lots and other paved surfaces throughout the United States and in foreign countries, especially in urban developments, to remove water accumulating on the surfaces thereof. In many municipalities, curbside storm vaults, or stormwater catch basins, are installed below grade along such paved roadways. Such catch basins are usually formed from concrete and are connected to a conduit that channels the stormwater away from the area to a relatively large water collection reservoir, or to a river, stream or other body of water.

A typical storm vault 2 which is used extensively in the streets of many municipalities in the United States is shown in FIG. 1 of the drawings. Such storm vaults 2 are usually made from concrete and are rectangular in transverse and longitudinal cross-sections, i.e., the vaults 2 are formed as a rectangular parallelepiped, with opposite front and rear side walls, opposite lateral side walls, a bottom wall and a top cover wall. The walls of the storm vault 2 define an interior cavity 3 which receives stormwater through an elongated, curbside opening, or open-curb stormwater inlet 4, formed in the front wall of the concrete vault 2, the vault 2 being positioned in the ground such that the curbside opening 4 is level with the surface of the paved roadway to receive runoff water accumulating on the roadway therethrough and into the internal cavity of the vault 2, where the water is directed to a channeling conduit forming part of the stormwater drainage system. There is also an access opening 6 formed through the thickness of the cover wall of the storm vault 2, which access opening 6 is covered by a storm grate or a manhole cover 8.

Many municipalities require the placement of a screen or filtering apparatus at the curbside opening 4 that prevents coarse materials and debris, such as leaves, stones, branches and manmade trash, carried by stormwater from entering the storm vault 2 through the curbside opening 4 formed therein and that collects within the internal cavity of the storm vault 2. Such coarse debris material may clog the drainage conduit connected to the storm vault 4 and may contribute to the pollution of the body of water to which the stormwater from the catch basin (storm vault) 4 collects.

One type of device used to protect curb inlets 4 from trash and debris that might typically enter an open curb inlet and accumulate in the below-ground storm vault 2 is referred to in the stormwater industry as an Automatic Retractable Screen, or simply, ARS, device. The basic purpose for the ARS device is to provide screen protection at the mouth of curb inlet openings 4 to prevent trash and debris from entering the inlet 4 during the dry season or during light rain events. The roadside trash and debris would then be collected during typical street-sweeping routines. The function of the ARS device is to remain closed until a pre-specified height of water in front of the screen of the device has accumulated sufficiently to force the screen to open, thus allowing the curb inlet 4 to accept the full flow of the storm event for which it was designed. The activation from closed to open, and vice versa, is required to occur by mechanical means only, since no electrical power is provided to the storm vault 2.

Some conventional ARS designs incorporate springs or counterbalances to perform this function. The spring-activated ARS device inherently has an increasing force (based on spring rate) that introduces more and more force as the screen opens wider to accept the incoming stormwater. In turn, this increasing spring force will create an undesirable higher head of water upstream entering the curb inlet opening. With regard to the counterbalance ARS devices, they tend to require significantly more space to install, and are believed to be very unreliable.

### OBJECTS AND SUMMARY OF THE INVENTION

It is an object of the present invention to provide an improved ARS device that is fittable at the curbside opening of an existing storm drainage basin.

It is another object of the present invention to provide an improved ARS device for use with a storm vault having a curbside opening, and which has a screen that is adjustable in width to accommodate curbside openings having various widths.

Is it a further object of the present invention to provide an improved ARS device having a pivotable screen, and which includes structure allowing for adjustment in the breakaway force required to pivot the screen.

It is yet a further object of the present invention to provide an improved ARS device for use with a storm vault having a curbside opening, the ARS device including a pivotable screen in which, once the required breakaway force for pivoting the screen is met, the screen substantially freely pivots without restriction and closes automatically under its own weight when the flow of stormwater through the curbside opening subsides.

In accordance with one form of the present invention, an improved ARS device for use with a storm vault having a curbside opening includes a mounting assembly having a bracket for mounting the ARS device to a side wall of the storm vault adjacent to the curbside opening, a pivotable screen, preferably formed of first and second sections arranged side-by-side, positioned inside the curbside opening of the storm vault near the front of the opening, structure affixed to the mounting assembly and the screen which allows the screen to pivot on the mounting assembly, and a magnetic release mechanism. The magnetic release mechanism holds the screen in a closed position to block debris carried by stormwater from entering the vault opening until the force of the stormwater exerted on the screen exceeds a predetermined and selectable value at which point the screen is released to pivot to an open position.

More specifically, and in one form of the present invention, the ARS device uses a sealed rare earth permanent magnet to hold the screen in the closed position until a sufficient head of water in front of the screen provides sufficient force to overcome the magnetic attraction between the magnet and a ferrous strike plate (or a second magnet) positioned in close proximity to the magnet and mechanically coupled to the screen, and allows the screen to break free of the magnetic force and pivot freely (with exception to weight and friction) to an open position. The benefit of such a novel design which employs a magnetic release mechanism over the conventional spring-activated ARS device is that, unlike springs used conventionally, once the screen breaks away from the magnet, it pivots with little restriction.

In a further preferred version of the ARS device of the present invention, the release mechanism which actuates pivotal movement of the screen incorporates a disc-shaped magnet that is fixed to the end of a socket head bolt. Adjusting the bolt moves the magnet closer or farther from a magnetic or magnetically-attractable strike plate operatively coupled to the hinged screen, thus allowing the installer to fine-tune the required breakaway force per the customer's requirements. Once the proper breakaway force is achieved, the bolt and magnet assembly are permanently locked in place with a locknut and thread lock adhesive.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of a stormwater drainage basin, or storm vault, for which the automatic retractable screen device of the present invention is adapted to be used.

FIG. 2 is a front perspective view of an Automatic Retractable Screen (ARS) device formed in accordance with the present invention and shown with the screen thereof in a closed position.

FIG. 3 is a rear perspective view of the ARS device of the present invention with the screen thereof shown in a closed position.

FIG. 4 is a front elevational view of the ARS device of the present invention with the screen thereof shown in a closed position.

FIG. 5 is another front elevational view of the ARS device of the present invention shown with the screen thereof in a closed position.

FIG. 6 is a top plan view of the ARS device of the present invention shown with the screen thereof in a closed position.

FIG. 7 is an exploded, front, bottom perspective view of the ARS device of the present invention.

FIG. 8 is an exploded, front perspective view of the ARS device of the present invention.

FIG. 9 is an exploded, front perspective view of a portion of the ARS device of the present invention.

FIG. 10 is a side elevational view of the ARS device of the present invention showing the screen thereof in a closed position.

FIG. 11 is a front perspective view of the ARS device of the present invention shown with the screen thereof in an open position.

FIG. 12 is a rear perspective view of the ARS device of the present invention shown with the screen thereof in an open position.

FIG. 13 is a side view of a portion of the ARS device of the present invention showing the screen thereof in a closed position and further illustrating a preferred form of the magnetic release mechanism of the ARS device.

FIG. 14 is a partially exploded, perspective view of a portion of the mounting assembly of the ARS device of the present invention.

FIG. 15 is a longitudinal cross-sectional view of the ARS device of the present invention taken through the center thereof and showing the screen thereof in a closed position, and further illustrating a preferred form of the magnetic release mechanism of the device.

FIG. 16 is an enlarged rear perspective view of a portion of the ARS device of the present invention and illustrating the preferred form of the magnetic release mechanism of the device.

FIG. 17 is an exploded perspective view of a portion of the magnetic release mechanism of the ARS device of the present invention.

FIG. 18 is a side view of the ARS device of the present invention showing the screen thereof in a fully open position.

FIG. 19 is a front perspective view of the ARS device of the present invention and illustrating its placement within the curbside opening of a storm vault which is shown in transparency, and further showing the screen thereof in a closed position.

FIG. 20 is a side elevational view of the ARS device of the present invention and illustrating its placement within the curbside opening of a storm vault which is shown in transparency, and further showing the screen thereof in a closed position.

FIG. 21 is a partially exploded, side elevational view of the ARS device of the present invention and illustrating its placement within the curbside opening of a storm vault, and further showing the screen thereof in a closed position.

FIG. 22 is a front perspective view of the ARS device of the present invention and illustrating its placement within the curbside opening of a storm vault which is shown in transparency, and further showing the screen of the ARS device in a closed position.

FIG. 23 is an enlarged, front perspective view of the ARS device of the present invention and a portion of the storm vault shown in FIG. 22, and illustrating its placement within the curbside opening of the storm vault which is shown in transparency, and further showing the screen of the ARS device in a closed position.

FIG. 24 is a side elevational view of the ARS device of the present invention and illustrating its placement within the curbside opening of a storm vault, and further showing the screen thereof in a closed position.

FIG. 25 is a side elevational view of the ARS device of the present invention and illustrating its placement within the curbside opening of a storm vault which is shown in transparency, and further showing the screen thereof in an open position.

FIG. 26 is a front perspective view of the ARS device of the present invention and illustrating its placement within the curbside opening of a storm vault which is shown in transparency, and further showing the screen thereof in an open position.

FIG. 27 is an enlarged, front perspective view of the ARS device of the present invention and a portion of the storm vault shown in FIG. 26, taken from a different angle from that of FIG. 26, and illustrating its placement within the curbside opening of a storm vault which is shown in transparency, and further showing the screen of the ARS device in an open position.

FIG. 28 is a side elevational view of a portion of the ARS device of the present invention and illustrating its placement within the curbside opening of a storm vault, and which the screen of the ARS device is shown in a fully open position.

FIG. 29 is a vector force diagram of the forces applied to the screen of the ARS device of the present invention by stormwater contacting the screen.

### DETAILED DESCRIPTION OF THE PREFERRED EMBODIMENTS

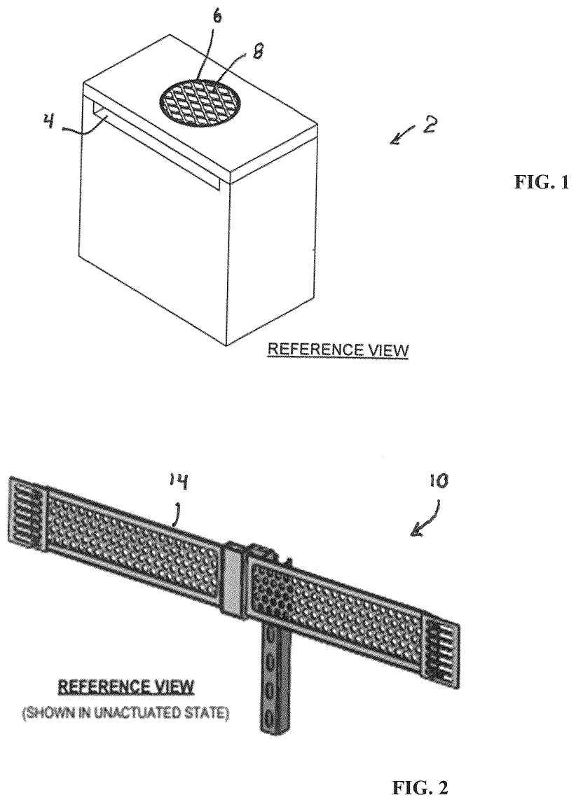

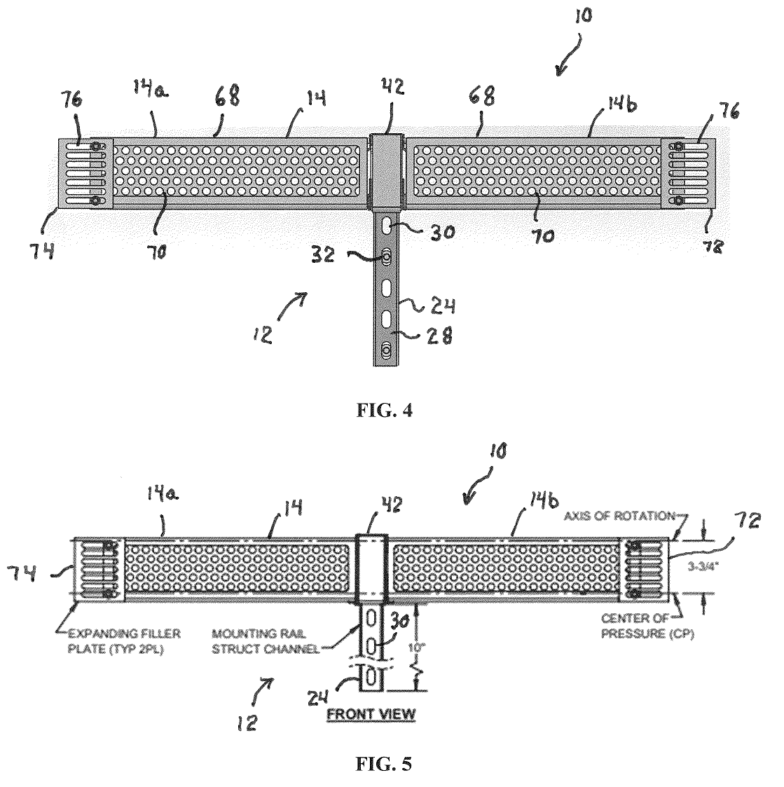

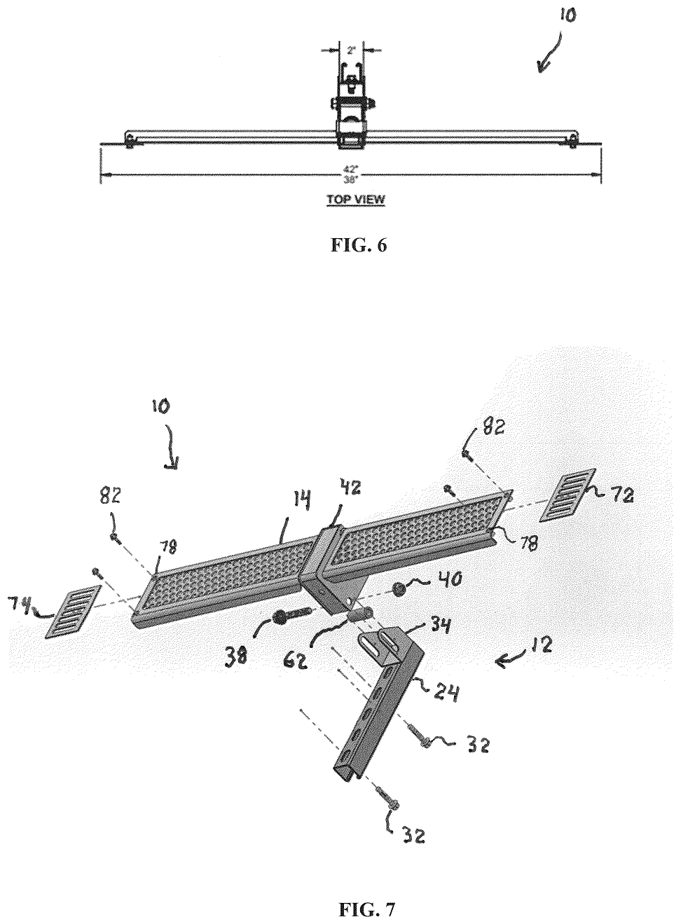

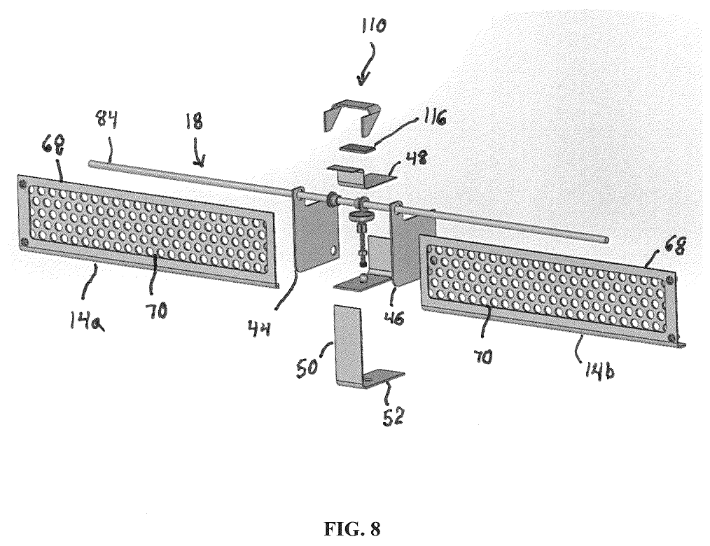

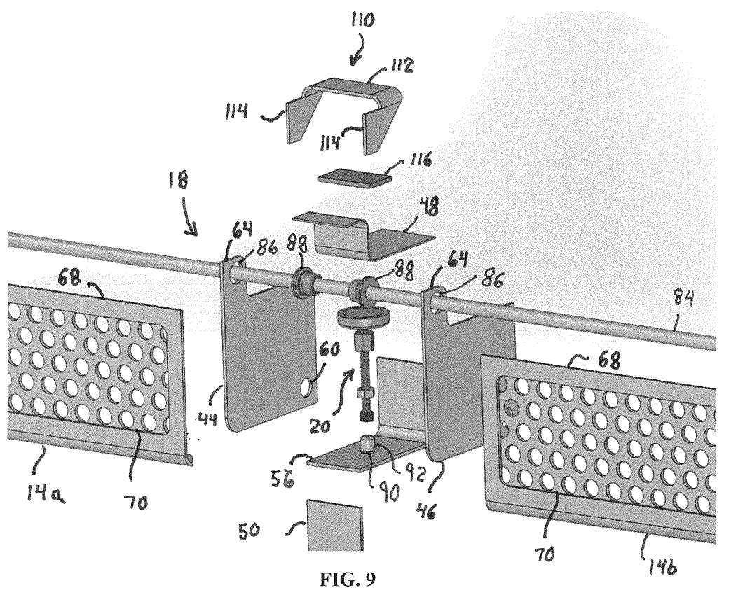

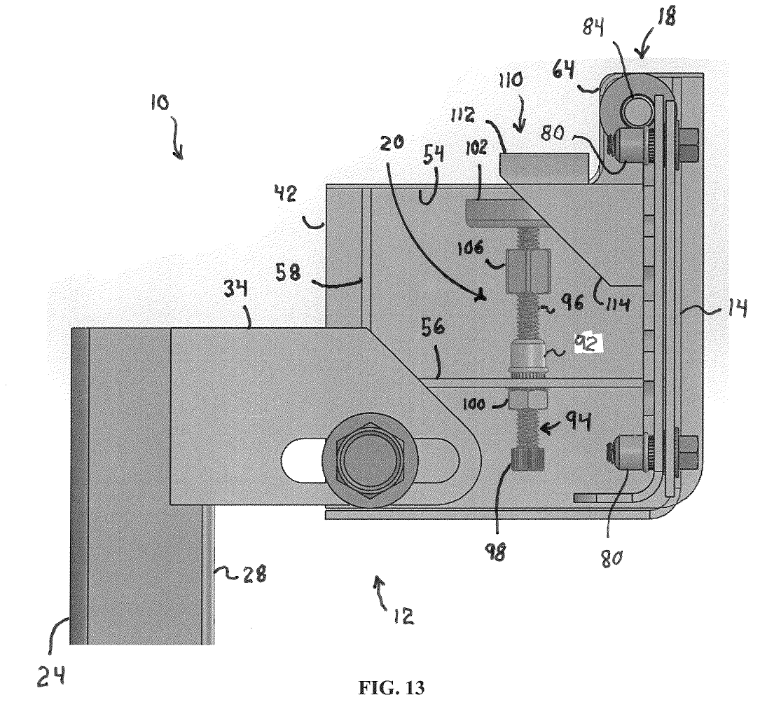

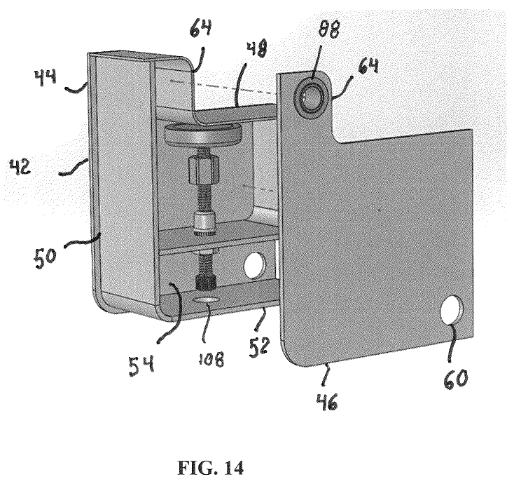

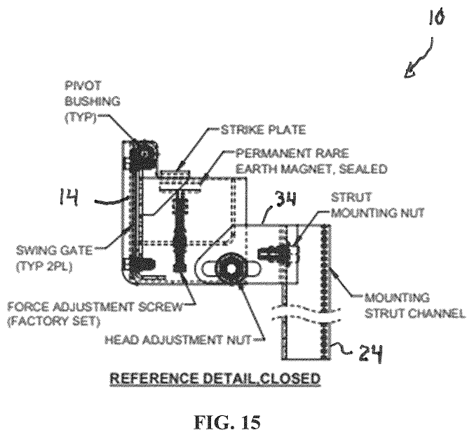

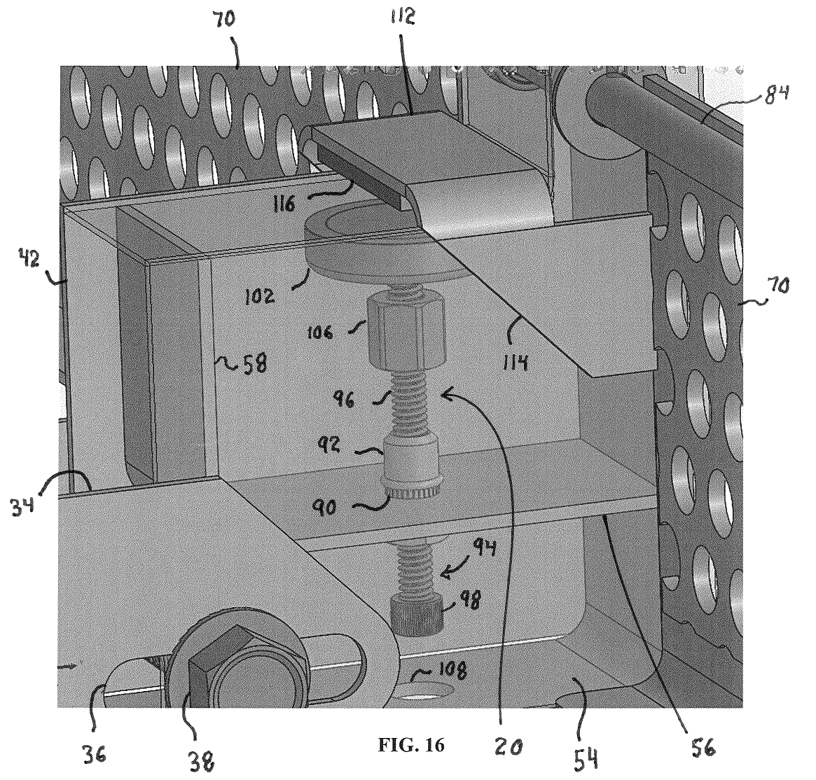

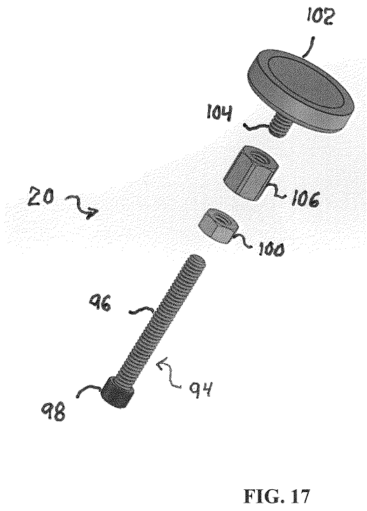

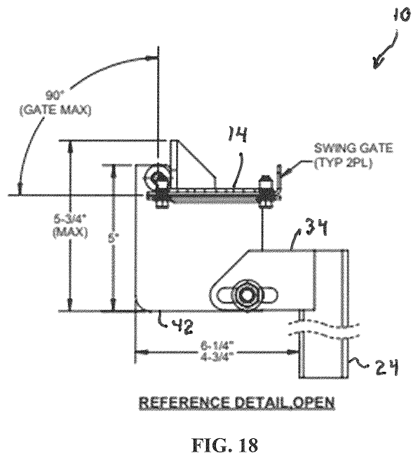

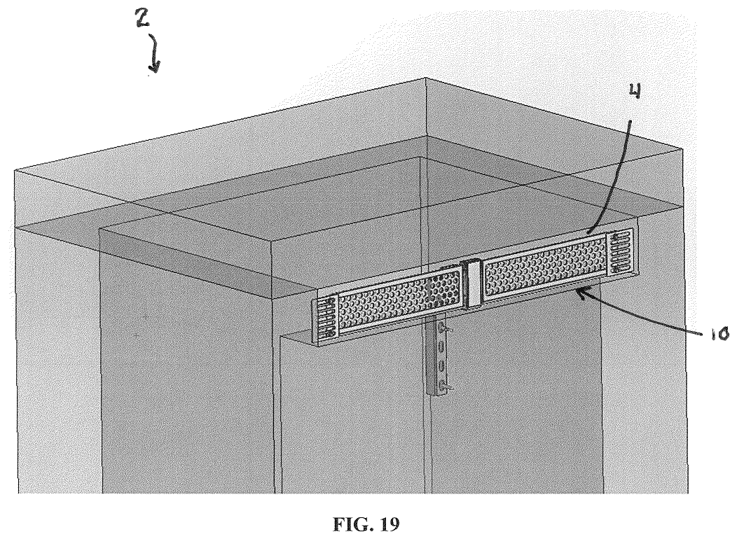

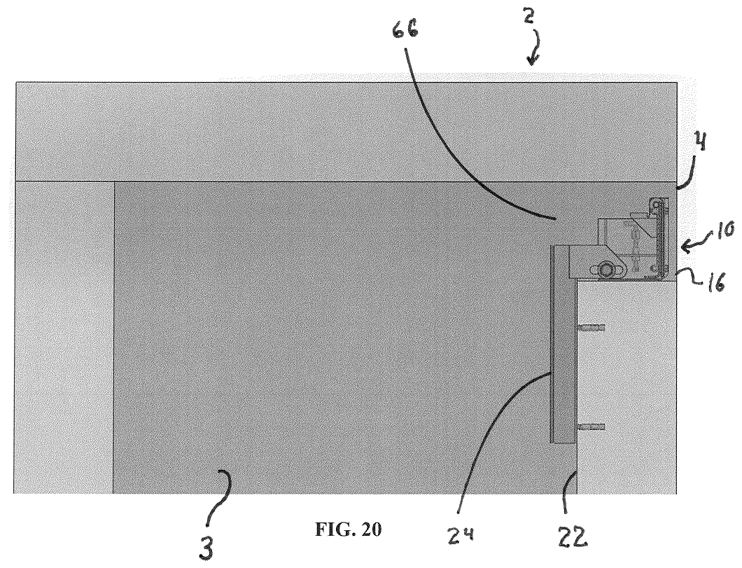

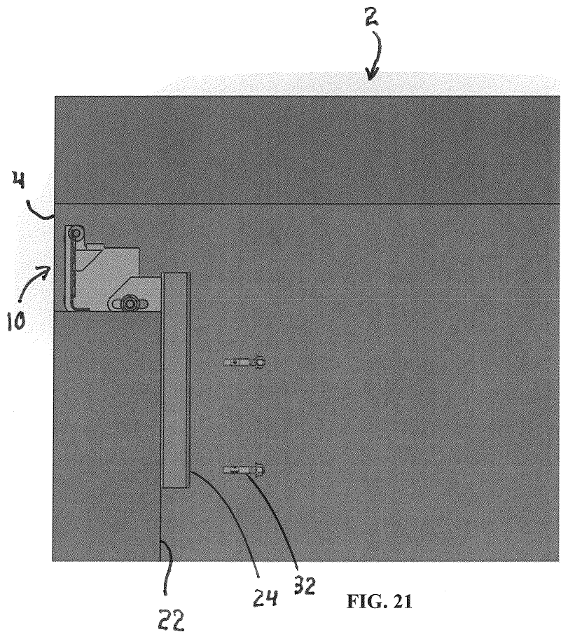

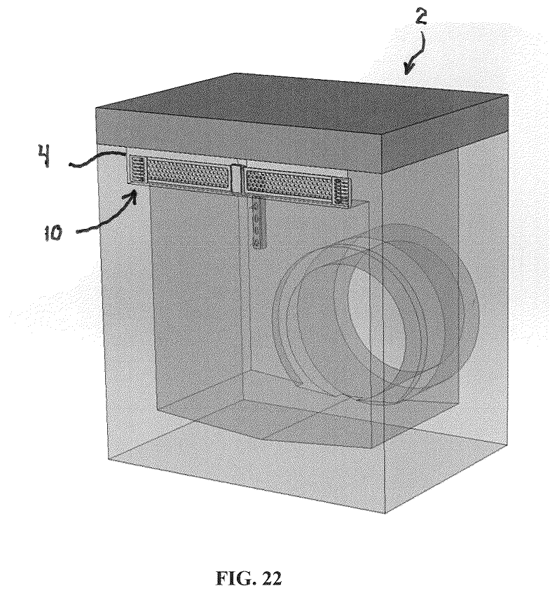

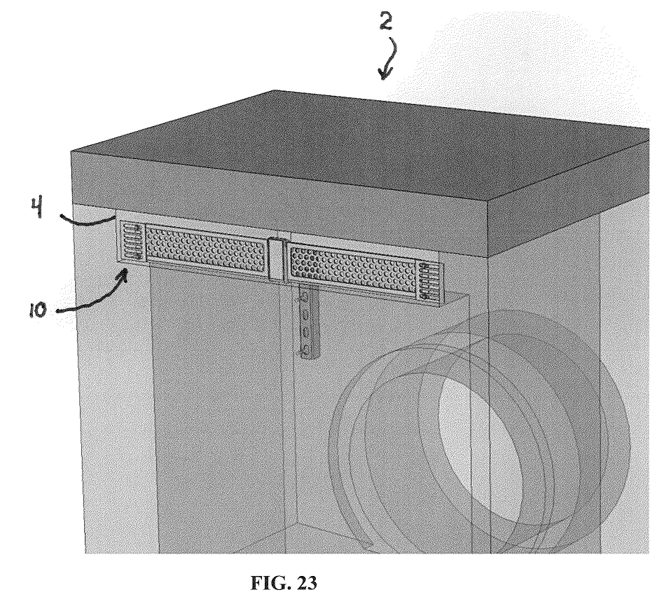

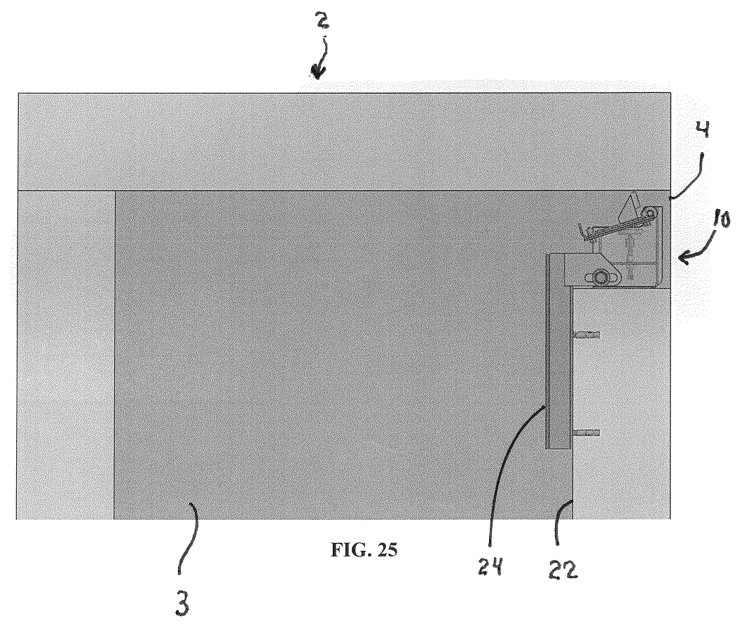

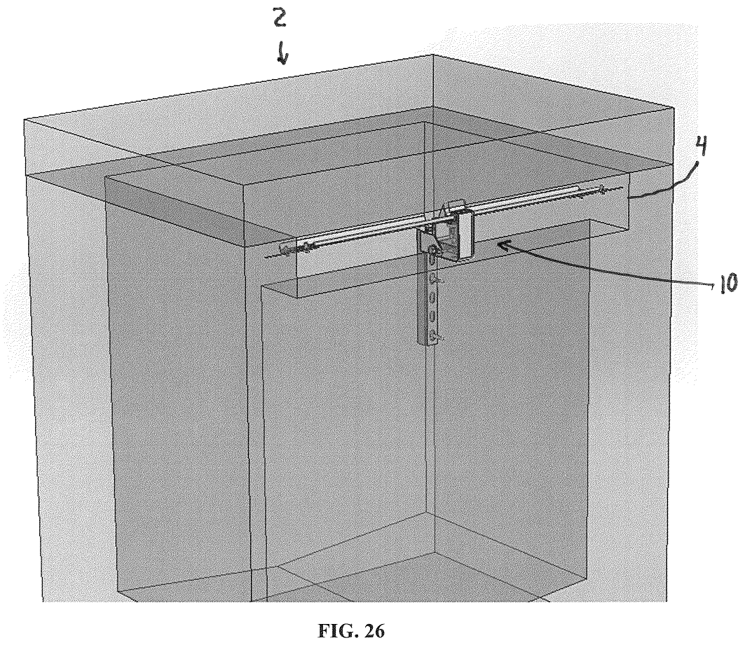

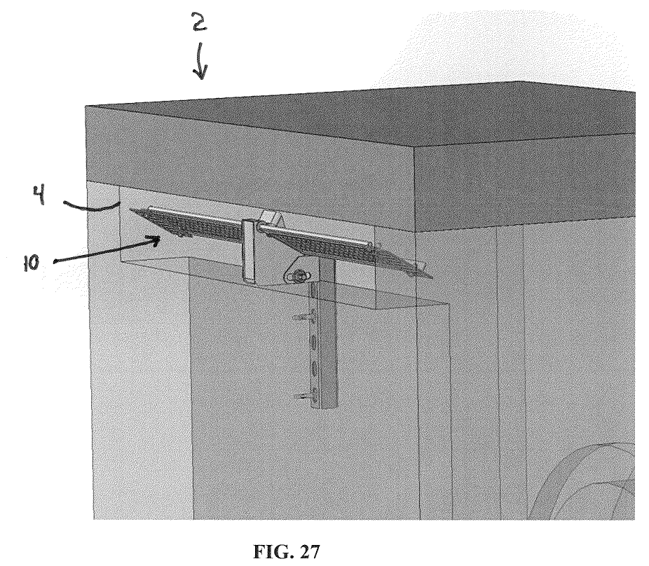

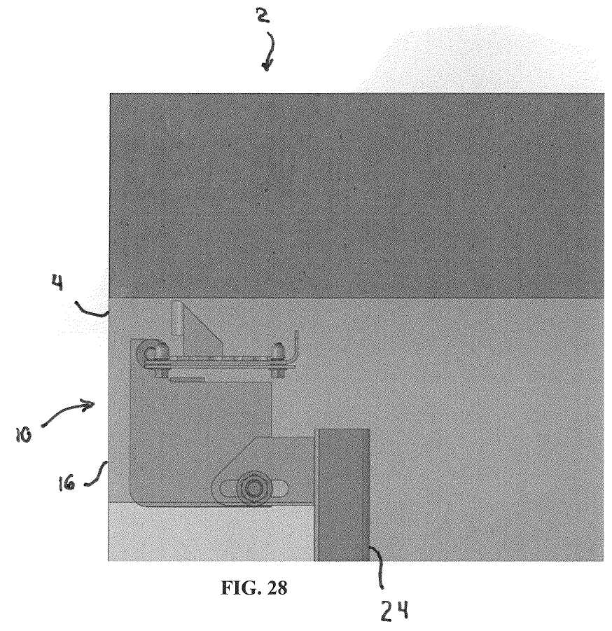

As can be seen from FIGS. 1-28 of the drawings, an Automatic Retractable Screen (ARS) device 10 constructed in accordance with the present invention, in its most basic form, includes a mounting assembly 12 for mounting the ARS device 10 to a side wall of the storm vault 2 adjacent to the curbside opening 4, a pivotable screen 14, preferably formed of first and second sections 14a, 14b arranged side-by-side, positioned inside the curbside opening 4 of the storm vault 2 near the front 16 of the opening 4, screen pivot structure 18 affixed to the mounting assembly 12 and the screen 14 which allows the screen 14 to pivot on the mounting assembly 12, and a magnetic release mechanism 20. Each of these components will now be described in greater detail.

As can be seen in FIGS. 2, 7, 9 and 11-14, the mounting assembly 12 of the ARS device 10 of the present invention not only is used to mount the ARS device 10 to a side wall 22 of a storm vault 2 but also allows adjustment of the pivotable screen 14 in depth and angular disposition within the curbside opening 4 of the storm vault 2. The mounting assembly 12 includes an elongated bracket 24 which is U-shaped in transverse cross section and formed of two spaced apart lateral side walls 26 which extend perpendicularly from a base wall 28 which faces the inner surface of a side wall 22 of the storm vault 2 when affixed thereto. The elongated bracket 24 includes a plurality of spaced apart slots 30 positioned along the length thereof and through the thickness of the base wall 28. The slots 30 are provided to receive concrete anchors 32 for mounting the elongated bracket 24 in a desired position against the inner surface of a side wall 22 of the storm vault 2 situated below the curbside opening 4.

The mounting assembly 12 further includes a pair of support plates 34 which extend perpendicularly from a top end portion of the elongated bracket 24 and which are joined to the lateral side walls 26 of the bracket 24. Each support plate 34 has formed through the thickness thereof a slot 36 which extends, like the support plates 34 themselves, perpendicularly to the longitudinal length of the elongated bracket 24. As will be described in greater detail, a machine bolt 38 is received by and passes through the slots 36 formed in the support plates 34, the threaded end of the shank of which receives a nut 40. The slots 36 are provided to allow adjustment to the position of the screen 14 within the curbside opening 4 both in lateral disposition and in angular disposition to compensate for differences in the thickness of the vault side wall 22 in which the curbside opening 4 is formed and irregularities in the wall 22 defining the opening 4 and slope of the opening 4.

The mounting assembly 12 further includes a housing 42 for holding therewithin the magnetic release mechanism 20. The housing 42 includes opposite first and second lateral side walls 44, 46, spaced apart from and parallel to each other, a generally Z-shaped top covering wall 48 joined to the top edges of the first and second lateral side walls 44, 46, a front wall 50 joined to the front edges of the first and second lateral side walls 44, 46, and a bottom wall 52 joined perpendicularly to (and preferably integrally formed with) the front wall 50 and joined to the bottom edges of the first and second lateral side walls 44, 46. Thus, the housing 42 defines an interior cavity 54 in which at least a portion of the magnetic release mechanism 20 of the ARS device 10 of the present invention is situated.

Inside the housing 42 is a horizontal mounting plate 56 for mounting the magnetic release mechanism 20, and a vertical support plate 58, preferably integrally formed with and perpendicularly disposed to the horizontal mounting plate 56, each of which extend across the interior cavity 54 of the housing 42 between the first and second lateral side walls 44, 46. The machine bolt 38 which is received by the slots 36 formed in the pair of support plates 34 passes through openings 60 formed in the first and second lateral side walls 44, 46 of the housing 42 and through a bushing 62 disposed between the lateral side walls 44, 46 so that the housing 42 is mounted between and supported by the support plates 34 of the mounting assembly 12. The housing 42 is thus adjustable on the support plates 34 relative to the longitudinal length of the elongated bracket 24 and angularly thereto by adjusting its lateral position and angular disposition on the pair of support plates 34 through the positioning of the machine bolt 38 within the slots 36.

Each of the first and second lateral side walls 44, 46 includes a portion 64 that extends upwardly beyond the top covering wall 48 of the housing 42. As will be described in greater detail, such upwardly extending portions 64 of the first and second lateral side walls 44, 46 of the housing 42 are used to pivotally support the screen 14 of the ARS device 10 of the present invention. As will be further seen, the housing 42 of the mounting assembly 12 is received at least partially within the curbside opening 4 of the storm vault 2 from the rear 66 thereof.

As further can be seen in FIGS. 2-8, 11 and 12, the screen 14 of the ARS device 10 of the present invention preferably is formed of first and second sections 14a, 14b arranged co-planarly. More specifically, the first section 14a of the screen 14 extends outwardly and perpendicularly to the first lateral side wall 44 of the housing 42 of the mounting assembly 12, and the second section 14b of the screen 14 extends outwardly and perpendicularly from the second lateral side wall 46 of the housing 42. Each of the first and second screen sections 14a, 14b is formed with a rectangular frame 68. A perforated plate 70, having a multiplicity of spaced apart holes formed through the thickness thereof, is joined to the rectangular frame 68 of each of the first and second screen sections 14a, 14b. The plate openings of the first and second sections 14a, 14b of the screen 14 are provided to allow stormwater to pass therethrough and into the curbside opening 4 of the storm vault 2 when the screen 14 is in a closed position and yet block any debris (leaves, branches, bottles and other manmade articles) carried by the stormwater from passing therethrough and into the interior of the storm vault 2.

In a preferred form of the ARS device 10 of the present invention, each of the first and second sections 14a, 14b of the screen 14 may include an extendable filler plate or grille 72, 74, such as shown in FIGS. 2-5, 7, 11 and 12 of the drawings. Since the width of the curbside opening 4 may vary from storm vault-to-storm vault, the grilles 72, 74 may be extended beyond the normal width of the first and second screen sections 14a, 14b to ensure that the entire width of the curbside opening 4 is protected against debris entering the storm vault 2. More specifically, the frame 68 of the first screen section 14a at the outermost lateral side thereof has adjustably mounted to it a first filler plate or grille 72 having a plurality of spaced apart slots 76 extending transversely therein. The outermost lateral side of the frame 68 includes top and bottom openings 78 formed through the thickness thereof and captively holding rivet nuts 80 which receive machine bolts 82 that also pass through the uppermost and lowermost slots 76 formed in the first grille 72.

Similarly, the second screen section 14b includes a second filler plate or grille 74. More specifically, the frame 68 of the second screen section 14b at the outermost lateral side thereof has adjustably mounted to it a second filler plate or grille 74 having a plurality of spaced apart slots 76 extending transversely therein. The outermost lateral side of the frame 68 includes top and bottom openings 78, formed through the thickness thereof and captively holding rivet nuts 80 which receive machine bolts 82 that also pass through the uppermost and lowermost slots 76 formed in the second grille 74.

Thus, the first and second grilles 72, 74 may be extended outwardly from the first and second screen sections 14a, 14b, respectively, and held in place by tightening the machine bolts 82 so that the perforated screen 14 covers the entire width of the curbside opening 4 of the storm vault 2.

The perforated screen 14 is pivotally mounted on the housing 42 of the mounting assembly 12 that holds the magnetic release mechanism 20. The pivot structure 18 which allows the screen 14 to pivot will now be described.

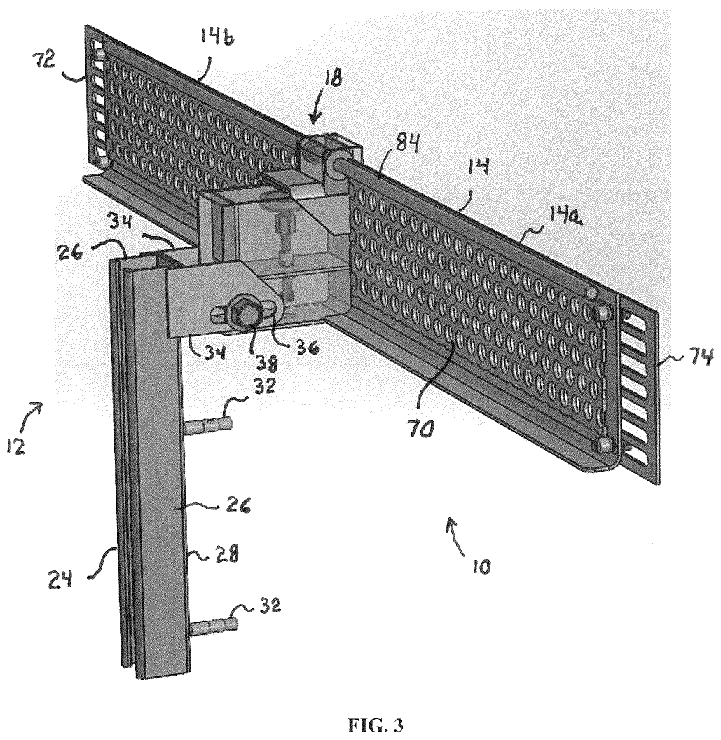

As can be seen from FIGS. 3, 8, 9, 11-13 and 16 of the drawings, there is a tubular bar 84 that is welded to the inside surface of the top side of the frames 68 of the first and second screen sections 14a, 14b. This bar 84 passes through openings 86 formed in the extended upper portions 64 of each of the first and second lateral side walls 44, 46 of the release mechanism housing 42 and through sleeve bearings or bushings 88 mounted in the openings 86. Thus, the bar 84 is affixed to and can rotate on the first and second lateral side walls 44, 46 of the housing 42 so that the first and second screen sections 14a, 14b joined to the bar 84 can pivot on the housing 42 from a closed position, in which the screen sections 14a, 14b are substantially parallel with the front wall 50 of the housing 42, to an inwardly sloped open position, or a perpendicular, fully open position with respect to the front wall 50 of the housing 42. In this open position of the screen 14, caused by the force of the stormwater exerted on the screen 14, the ARS device 10 of the present invention will allow a stormwater surge to freely pass through the curbside opening 4 of the storm vault 2. When the stormwater surge subsides, the screen 14 by its own weight will return to the closed position covering the curbside opening 4 of the storm vault 2, allowing stormwater to pass through the perforated screen 14 but not debris carried by the stormwater or in the roadway and collecting at the screen 14.

The improved ARS device 10 of the present invention employs a magnetic release mechanism 20 that holds the screen 14 in a closed position to block debris carried by stormwater from entering the vault opening 4 until the stormwater builds up sufficiently to cause the magnetic release mechanism 20 to unlatch and allow the screen 14 to pivot to an open position. Reference should now be had to FIGS. 3, 8, 9 and 13-17 which show a preferred form of the magnetic release mechanism 20 of the ARS device 10 of the present invention.

The horizontal mounting plate 56 within the interior cavity 54 of the housing 42 of the mounting assembly 12 and in which the magnetic release mechanism 20 is situated has an opening 90 formed through the thickness thereof. A threaded rivet nut 92 is mounted in this opening 90 and extends outwardly from the upper side of the mounting plate 56. A force adjustment screw (which is preferably factory set) in the form of a threaded machine bolt 94 has its threaded shank 96 passing through the rivet nut 92 and the horizontal mounting plate 56 and extending upwardly through the interior cavity 54 of the housing 42 a predetermined distance above the upper side of the mounting plate 56 and towards the top covering wall 48 of the housing 42. Between the bolt head 98 and the lower side of the horizontal mounting plate 56 is a hexagonal nut 100 threaded onto the shank 96 of the machine bolt 94, acting as the force adjustment screw. Tightening this hexagonal nut 100 against the bottom side of the horizontal mounting plate 56 will prevent the machine bolt 94 from rotating and will fix the length of the threaded shank 96 thereof which extends above the top side of the horizontal mounting plate 56.

Preferably, an encased rare earth Neodymium permanent magnet 102 having a short threaded stud 104 is affixed to the free end of the threaded shank 96 of the machine bolt 94 using a thumb nut or standoff 106 having a female/female thread on each end. An adhesive, such as a permanent (or non-permanent) thread lock glue, is applied to the threaded stud 104 of the encased magnet 102 and to the threaded free end of the bolt 94 prior to their being threaded into the thumb nut 106 to prevent the parts from inadvertently separating. Preferably, the encased Neodymium magnet 102 having a threaded stud 104 is Part No. 3506K64 distributed by McMaster-Carr Supply Company of Douglasville, Georgia.

Alternative structures to that of the described encased and studded permanent magnet 102 may be suitable for use in the magnetic release mechanism 20 of the ARS device 10 of the present invention. For example, a magnet holder (not shown) preferably in the form of a cylindrical cup may be mounted on the free end of the force adjustment screw 94. The magnet holder, if such is used, would include a recess formed in the upper surface thereof, which receives and secures in place with an adhesive a permanent rare earth magnet.

The force adjustment screw (e.g., machine bolt 94) may be a hex drive threaded screw or have a Phillips or slotted head 98. An opening 108 may be formed in the bottom wall 52 of the housing 42 and disposed in alignment with the head 98 of the screw 94 to provide access to the screw head 98 using a hex wrench or a screwdriver to adjust the position of the permanent magnet 102 affixed to the free end of the screw 94 within the housing 42.

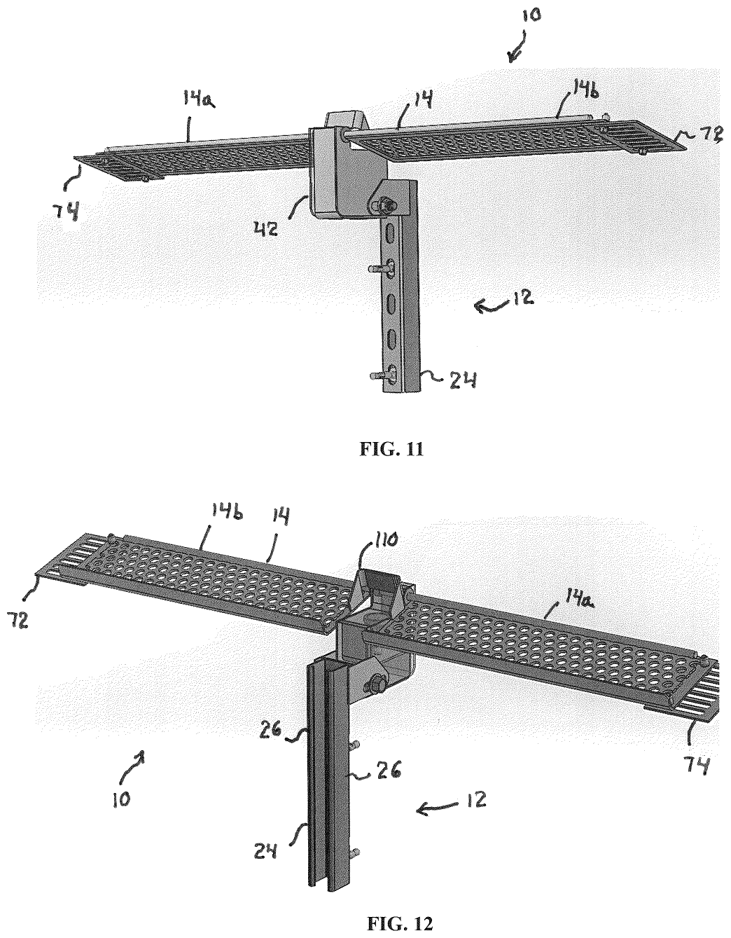

A clevis-like actuating bracket 110 includes a top wall 112 that extends over the permanent magnet 102 and the top covering wall 48 of the housing 42 that holds the magnetic release mechanism 20 therein. The actuating bracket 110 includes two articulated, spaced apart, parallel lateral side walls 114 that extend from the top wall 112 of the actuating bracket 110. The free ends of the articulated lateral side walls 114 of the actuating bracket 110 are respectively joined to the inside surfaces of the innermost lateral sides of the frames 68 of the first and second screen sections 14a, 14b which are closest to the housing 42 for the magnetic release mechanism 20. A strike plate 116 formed of a ferrous or other magnetic material, or even defined by a second magnet, is affixed to the underside of the top wall 112 of the actuating bracket 110 at least in partial alignment with and overlying the permanent magnet 102 of the magnetic release mechanism 20. Accordingly, the magnetic attraction between the permanent magnet 102 of the magnetic release mechanism 20 and the strike plate 116 of the actuating bracket 110, through the housing top covering wall 48 that is made from a non-magnetic material, will maintain the screen 14 in a closed position within the curbside opening 4 of the storm vault 2. However, if sufficient force is exerted on the screen 14 of the ARS device 10 by a stormwater surge that overcomes the magnetic attraction between the permanent magnet 102 and the strike plate 116, such will cause the strike plate 116 and actuating bracket 110 to lift away from the permanent magnet 102 and the housing 42 so that the screen 14 may pivot inwardly of the curbside opening 4 to allow the surge of stormwater to pass therethrough and into the storm vault 2. When the force exerted on the screen 14 of the ARS device 10 by the surge of stormwater subsides, the screen 14 by its own weight will pivot towards a closed position, with the strike plate 116 affixed to the top wall 112 of the actuating bracket 110 again residing over the permanent magnet 102 of the magnetic release mechanism 20. Magnetic attraction between the strike plate 116 and the permanent magnet 102 through the housing top covering wall 48 will latch the screen 14 of the ARS device 10 in the closed position until again being overcome by water pressure caused by a stormwater surge. The ARS device 10 of the present invention with the screen 14 in the open position is shown in FIGS. 11, 12, 18 and 25-28 of the drawings. The ARS device 10 of the present invention with the screen 14 in the closed position is shown in FIGS. 2-10, 13, 15, 16 and 19-24 of the drawings.

The force adjustment screw, which as described previously is preferably in the form of a threaded machine bolt 94, may be turned clockwise or counterclockwise to adjust the position of the permanent rare earth magnet 102 with respect to the ferrous or magnetic strike plate 116 mounted on the actuating bracket 110 situated above the magnet 102. By adjusting the relative position of the permanent magnet 102 with respect to the strike plate 116, and thus the degree of magnetic attraction between the strike plate 116 and the permanent magnet 102, the amount of force caused by stormwater required to overcome the magnetic attraction to unlatch the screen 14 to pivot from a closed position to an open position may be adjusted. The lock nut 100 on the force adjustment screw 94 may be turned to lock in place the position of the permanent magnet 102 relative to the strike plate 116.

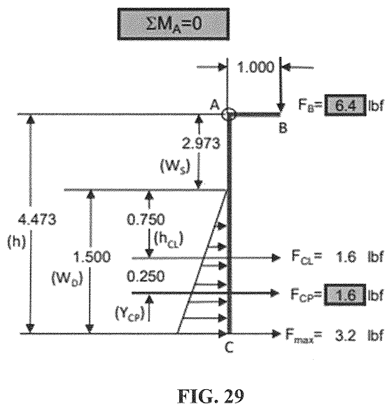

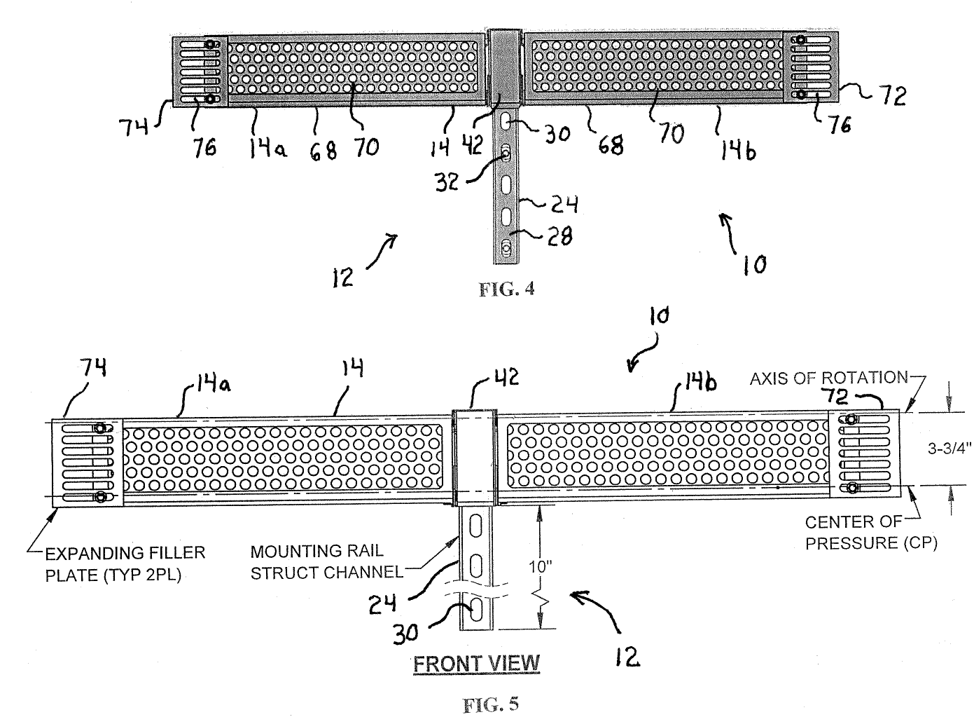

FIG. 29 is a diagram relating to a vector force free body analysis of the ARS device 10 of the present invention, and this diagram should be read in conjunction with Table I and Equations 1-5 which are set forth below:

TABLE I
ARS Design Aid.

| | | | | |
|---|---|---|---|---|
| Plate Height (h) | 4.473 | in | 0.373 | ft |
| Plate Length (b) (see bullet note) | 39.625 | in | 3.302 | ft |
| Water Depth for Activation (W_{D}) | 1.500 | in | 0.125 | ft |
| Distance to Magnet Force F₁ | 1.000 | in | 0.083 | ft |
| Plate Angle from Horizontal (θ) | 90.0 | deg | 1.571 | rad |
| H2O Density (Y) | 0.036 | lb/in³ | 62.4 | lb/ft³ |
| Wet Area on Plate (A_{W}) | 59.44 | in² | 0.413 | ft² |
| Top of Plate to Water Surface (W_{S}) | 2.973 | in | 0.24779 | ft |
| Height of Water Force Centerline | 0.750 | in | 0.063 | ft |
| (h_{CL}) | | | | |
| 2nd Moment of Inersia (I_{XX}) | 11.1 | in⁴ | 5.4E−04 | ft⁴ |
| Center of Pressure (Y_{CP}) | 0.250 | in | 0.021 | in |
| Pressure @ Centerline Height (P_{CL}) | 0.027 | psi | | |
| Pressure @ Bottom (Pmax) | 0.054 | psi | | |

$$F = P * A \qquad Equation 1$$

$$P = p * g * h \qquad Equation 2$$

$$Y = p * g = 62.4 lb / {ft}^{3} \qquad Equation 3$$

$${Y}_{CP} = \frac{{I}_{XX} * Sin ( θ )}{{h}_{CL} * {A}_{W}} \qquad Equation 4$$

$${I}_{XX} = \frac{b * {h}^{3}}{12} \qquad Equation 5$$

More specifically, Table I and FIG. 29 describe the vector forces acting on the ARS device 10 of the present invention and show how the proper magnetic force (F_{B}) is determined for a particular application, with respect to the physical dimensions of the screen 14 of the ARS device 10, including the screen height, also referred to as the plate height (h), from the pivot point of the screen 14 to its lowermost extent, the overall width of the screen 14, also referred to as the plate length (b), and the distance of the magnetic strike plate 116 to the magnet force (F₁), as well as the required water depth (W_{D}) adjacent the screen 14 for activation of the ARS device 10 to unlatch the screen 14 and allow the screen 14 to pivot from a closed position to an open position.

Stated another way, and with reference to Table I and FIG. 29, the actual screen height is defined as “h”, and the moment arm is the distance from the center of rotation “A” to the force acting at the center of pressure “F_{CP}”. The resulting force “F_{CP}” and moment arm are calculated and based on the depth of the water “W_{D}” pushing on the screen. “ΣM_{A}=0” states that the sum of the moments about point “A” (point of rotation) must equal zero just prior to adding sufficient horizontal force at plane F_{CP}, to overcome (break away) the vertical magnetic force acting at distance A-B. The water depth for activation is preferably provided by the customer who purchases the ARS device 10.

Even more specifically, Table I and FIG. 29 are provided as an example to show the vector force free body analysis of an ARS device 10 constructed in accordance with the present invention and having particular dimensions. In this example of the ARS device 10, the screen or plate height (h) is selected as 4.473 inches, the screen width or plate length (b) is selected as 39.625 inches, the water depth (W_{D}) for activating the ARS device 10 of the present invention is chosen as 1.500 inches, the distance-to-magnet force (F₁) is 1.000 inches, the screen or plate angle from the horizontal (θ) is 90.0 degrees, and the water (H₂O) density (Y) is 0.036 lb/in³, the wet area on the screen or plate (A_{W}) is 59.44 in², the top of the screen or plate to the water surface (W_{S}) is 2.973 inches, the height of the water force centerline (h_{CL}) is 0.75 inches, the second moment of inertia (I_{XX}) is 11.1 in⁴, the center of pressure (Y_{CP}) is 0.25 inches, the pressure at the centerline height (P_{CL}) is 0.027 psi and the pressure at the bottom of the screen (Pmax) is 0.054 psi.

Equations 1 through 3 are standard equations for basic fluid analysis and are well known to one skilled in the art. Equation 4 is used to determine the center of pressure, and Equation 5 is used to determine the second moment of inertia for a rectangle (which is substantially the shape of the screen 14), and these equations are also well known to one skilled in the art.

In determining the vector forces on the ARS device 10 of the present invention, the following notes should be observed:
Use the Combined length of each Plate (i.e., screen 14) for (b) value. Do not include the fixed center magnet housing 42 in this measurement.
The magnitude of force at the center of pressure (F_{CP}) is always equal to the centerline force (F_{CL}) but acts at a distance Y_{CP} lower than the centerline force.
Only forces F_{B} and F_{CP} are required for the Free Body moment analysis.
This analysis does not account for the weight or friction of the moving parts; these effects will be determined empirically.

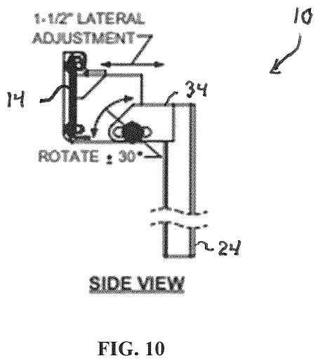

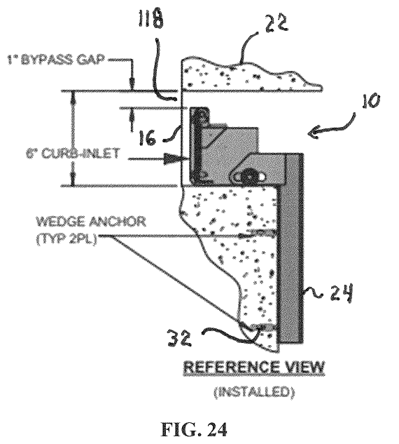

Reference should now be had to FIG. 24 of the drawings which shows the ARS device 10 of the present invention installed in the curbside opening 4 of a storm vault 2. It may be seen from FIG. 24 how the ARS device 10 is mounted to the inner surface of the side wall 22 of the storm vault 2 that is adjacent to the curbside opening 4 and how it is positioned within the curbside opening 4. It can also clearly be seen from FIG. 24 of the drawings that the screen 14 may be positioned near the front 16 or mouth of the curbside opening 4 by adjusting the position of the housing 42 that holds the magnetic release mechanism 20 on the pair of support plates 34 of the mounting assembly 12 and where the machine bolt 38 resides in the slot 36 of each support plate 34. Preferably, the length of the slots 36 provide a lateral adjustment of the position of the screen 14 within the curbside opening 4 of about one and a half (1½) inches, which should be sufficient for most anticipated applications. This lateral adjustment is depicted in FIG. 10 of the drawings. Furthermore, and as mentioned previously, the housing 42 for the magnetic release mechanism 20 may be rotated on the pair of support plates 34 of the mounting assembly 12 by loosening the machine bolt 38 received in the slots 36 of the support plates 34. This adjustment is provided to the ARS device 10 of the present invention to accommodate curbside openings 4 which are not necessarily horizontal. In a preferred form of the ARS device 10 of the present invention, and as shown in FIG. 10, a rotational adjustment of +30 degrees to −30 degrees of the housing 42 and screen 14 with respect to the support plates 34 of the mounting assembly 12 is provided, as this amount of rotational adjustment should be sufficient to compensate for non-horizontal, or sloping, curbside openings 4 in most applications.

As also shown in FIG. 24, the height of the screen 14 of the ARS device 10 of the present invention is preferably chosen to be less than the height of the curbside opening 4 in which it is placed so as to leave a bypass gap 118 between the screen 14 and the interior vault wall 22 defining the top of the curbside opening 4. This bypass gap 118 is provided in the event a stormwater surge is so great that additional unrestricted flow of water into the storm vault 2 through the bypass gap 118 is required or if the screen 14 becomes clogged.

The Automatic Retractable Screen (ARS) device 10 of the present invention employs a magnetic release mechanism 20 which allows the screen 14 to pivot with little restriction once the magnetic attraction between the magnet 102 and the strike plate 116 is overcome. Such a design overcomes the disadvantages inherent with conventional spring-actuated ARS devices which introduce more and more force as the screen opens wider to accept the incoming stormwater. This increasing spring force of conventional ARS devices creates an undesirable higher head of water upstream entering the curb inlet 4. Additionally, the ARS device 10 of the present invention is simple in construction and includes designed-in adjustability features to help account for irregularities in the curb inlets 4 of typical storm vaults 2. Furthermore, the expanding filler plates or grilles 72, 74 adjustably mounted on the first and second sections 14a, 14b of the screen 14 are provided to account for variations in curb inlet mouth widths.

The ARS device 10 of the present invention is preferably constructed of non-magnetic 300 series stainless steel with the exception of the permanent magnet 102 (preferably, a Neodymium rare earth magnet) and the strike plate 116 (preferably, formed from a nickel-coated, low carbon steel), which is magnetic.

The automatic retractable screen device 10 of the present invention will now be further described.

In a first embodiment of the present invention, an automatic retractable screen device 10 for use with a storm vault 2 is disclosed herein. The storm vault 2 defines an interior cavity 3 and has a side wall 22 and a vault opening 4 formed in the side wall 22, the vault opening 4 allowing stormwater to flow therethrough and into the interior cavity 3 of the storm vault 2. The automatic retractable screen device 10 in accordance with the first embodiment of the present invention preferably comprises a mounting assembly 12 for mounting the automatic retractable screen device 10 to the side wall 22 of the storm vault 2 and in close proximity to the vault opening 4; a pivotable screen 14 positionable to be in alignment with the vault opening 4 of the storm vault 2 when the automatic retractable screen device 10 is mounted within the interior cavity 3 of the storm vault 2; structure affixed to the mounting assembly 12 and the screen 14 and configured to allow the screen 14 to pivot on the mounting assembly 12 between a closed position and an open position, the open position being different from the closed position; and a magnetic release mechanism 20 operatively coupled to the screen 14, wherein the magnetic release mechanism 20 holds the screen 14 in the closed position to block debris carried by the stormwater from entering the vault opening 4 until a force of the stormwater exerted on the screen 14 exceeds a predetermined value at which point the screen 14 is released to pivot to the open position.

In the first embodiment of the automatic retractable screen device 10 of the present invention described above, the mounting assembly 12 may include a bracket 24 configured to be affixable to the side wall 22 of the storm vault 2.

In the first embodiment of the automatic retractable screen device 10 of the present invention described above, the mounting assembly 12 may include at least one support plate 34, the at least one support plate 34 having a slot 36 formed through the thickness thereof, and a fastener 38 received by the slot 36 and adjustably positionable along a length of the slot 36. The structure configured to allow the screen 14 to pivot between the closed position and the open position is operatively coupled to the fastener 38 received by the slot 36 and is adjustable in position relative to the at least one support plate 34 so that the screen 14 is adjustably positionable relative to the vault opening 4 when the automatic retractable screen device 10 is mounted within the interior cavity 3 of the storm vault 2.

In the first embodiment of the automatic retractable screen device 10 of the present invention described above, the magnetic release mechanism 20 may include a permanent magnet 102, a strike plate 116 having a structure which is magnetically attractable to the permanent magnet 102, and a bracket 110 interconnecting the strike plate 116 and the screen 14, the strike plate 116 being disposed in at least partial alignment with and in close proximity to the permanent magnet 102 when the screen 14 is in the closed position, the permanent magnet 102 and the strike plate 116 being spaced apart by a separation distance when the screen 14 is in at least one of the closed position and the open position.

In the first embodiment of the automatic retractable screen device 10 of the present invention described above, the magnetic release mechanism 20 may include structure for adjusting the separation distance between the permanent magnet 102 and the strike plate 116.

In the first embodiment of the automatic retractable screen device 10 of the present invention described above, the mounting assembly 12 may include a mounting plate 56, and the magnetic release mechanism 20 may further include an elongated member 94, the elongated member 94 being adjustably mounted on the mounting plate 56, the elongated member 94 having an axial end on which is mounted the permanent magnet 102, the axial end of the elongated member 94 and the permanent magnet 102 mounted thereon extending outwardly from the mounting plate 56 an adjustable distance thereby causing the separation distance between the permanent magnet 102 and the strike plate 116 to be adjusted.

In the first embodiment of the automatic retractable screen device 10 of the present invention described above, the screen 14 may include opposite lateral edges, and the automatic retractable screen device 10 may further comprise screen extension members 72, 74, each screen extension member 72, 74 being adjustably mounted on a respective opposite lateral edge of the screen 14 to extend outwardly from or adjust inwardly towards the respective opposite lateral edge of the screen 14 a desired distance in order to provide a combination of the screen 14 and the screen extension members 72, 74 with an adjustable overall width.

In a second embodiment of the present invention, an automatic retractable screen device 10 for use with a storm vault 2 is disclosed herein. As mentioned previously, the storm vault 2 defines an interior cavity 3 and has a side wall 22 and a vault opening 4 formed in the side wall 22, the vault opening 4 allowing stormwater to flow therethrough and into the interior cavity 3 of the storm vault 2. The automatic retractable screen device 10 in accordance with the second embodiment of the present invention preferably comprises a bracket 24 configured to be affixable to the side wall 22 of the storm vault 2; at least one support plate 34 affixed to the bracket 24 and extending therefrom, the at least one support plate 34 having a slot 36 formed through the thickness thereof, and a fastener 38 received by the slot 36 and adjustably positionable along a length of the slot 36; a housing 42, the housing 42 being mounted to the at least one support plate 34 by the fastener 38 and being adjustable on the at least one support plate 34 by adjustment of the position of the fastener 38 in the slot 36 of the at least one support plate 34; a pivotable screen 14 positionable to be in alignment with the vault opening 4 of the storm vault 2 when the automatic retractable screen device 10 is mounted within the interior cavity 3 of the storm vault 2; a pivot rod 84 operatively coupled to the housing 42 and the screen 14 and configured to allow the screen 14 to pivot on the housing 42 between a closed position and an open position, the open position being different from the closed position; and a magnetic release mechanism 20 operatively coupled to the screen 14, wherein the magnetic release mechanism 20 holds the screen 14 in the closed position to block debris carried by the stormwater from entering the vault opening 4 until a force of the stormwater exerted on the screen 14 exceeds a predetermined value at which point the screen 14 is released to pivot to the open position.

In the second embodiment of the automatic retractable screen device 10 of the present invention described above, the housing 42 may define an interior cavity 54, and the magnetic release mechanism 20 may at least partially reside in the interior cavity 54 of the housing 42. Furthermore, the housing 42 may include a mounting plate 56 disposed within the interior cavity 54 thereof, and the magnetic release mechanism 20 may include an elongated member 94 mounted on the mounting plate 56, the elongated member 94 having an axial end, a permanent magnet 102 mounted on the axial end of the elongated member 94, a strike plate 116 having a structure which is magnetically attractable to the permanent magnet 102, and a bracket 110 interconnecting the strike plate 116 and the screen 14, the strike plate 116 being disposed in at least partial alignment with and in close proximity to the permanent magnet 102 when the screen 14 is in the closed position, the permanent magnet 102 and the strike plate 116 being spaced apart by a separation distance when the screen 14 is in at least one of the closed position and the open position.

In the second embodiment of the automatic retractable screen device 10 of the present invention described above, the elongated member 94 may be adjustably mounted on the mounting plate 56, the axial end of the elongated member 94 and the permanent magnet 102 mounted thereon extending outwardly from the mounting plate 56 an adjustable distance thereby causing the separation distance between the permanent magnet 102 and the strike plate 116 to be adjusted.

In the second embodiment of the automatic retractable screen device 10 of the present invention described above, the screen 14 may include opposite lateral edges, and the automatic retractable screen device 10 may further comprise screen extension members 72, 74, each screen extension member 72, 74 being adjustably mounted on a respective opposite lateral edge of the screen 14 to extend outwardly from or adjust inwardly towards the respective opposite lateral edge of the screen 14 a desired distance in order to provide a combination of the screen 14 and the screen extension members 72, 74 with an adjustable overall width.

In a third embodiment of the present invention, an automatic retractable screen device 10 for use with a storm vault 2 is disclosed herein. As mentioned previously, the storm vault 2 defines an interior cavity 3 and has a side wall 22 and a vault opening 4 formed in the side wall 22, the vault opening 4 allowing stormwater to flow therethrough and into the interior cavity 3 of the storm vault 2. The automatic retractable screen device 10 in accordance with the third embodiment of the present invention preferably comprises a bracket 24 configured to be affixable to the side wall 22 of the storm vault 2; at least one support plate 34 affixed to the bracket 24 and extending therefrom, the at least one support plate 34 having a slot 36 formed through the thickness thereof, and a fastener 38 received by the slot 36 and adjustably positionable along a length of the slot 36; a housing 42 defining an interior cavity 54, the housing 42 being mounted to the at least one support plate 34 by the fastener 38 and being adjustable angularly on the at least one support plate 34 and in relative position with respect to the at least one support plate 34 by adjustment of the position of the fastener 38 in the slot 36 of the at least one support plate 34; a pivotable screen 14 positionable to be in alignment with the vault opening 4 of the storm vault 2 when the automatic retractable screen device 10 is mounted within the interior cavity 3 of the storm vault 2, the screen 14 being adjustable in distance relative to the vault opening 4 and in angular disposition relative thereto by adjustment of the housing 42 on the at least one support plate 34 when the automatic retractable screen device 10 is mounted within the interior cavity 3 of the storm vault 2, the screen 14 having an overall weight; a pivot rod 84 operatively coupled to the housing 42 and the screen 14 and configured to allow the screen 14 to pivot on the housing 42 between a closed position and an open position, the open position being different from the closed position; and a magnetic release mechanism 20 operatively coupled to the screen 14 and at least partially residing within the interior cavity 54 of the housing 42, wherein the magnetic release mechanism 20 holds the screen 14 in the closed position to block debris carried by the stormwater from entering the vault opening 4 until a force of the stormwater exerted on the screen 14 exceeds a predetermined and selectable value at which point the screen 14 is released to pivot to the open position. Preferably, the housing 42 includes a mounting plate 56 disposed within the interior cavity 54 thereof. The magnetic release mechanism 20 preferably includes an elongated member 94 mounted on the mounting plate 56, the elongated member 94 having an axial end, a permanent magnet 102 mounted on the axial end of the elongated member 94, a strike plate 116 having a structure which is magnetically attractable to the permanent magnet 102, and a bracket 110 interconnecting the strike plate 116 and the screen 14, the strike plate 116 being disposed in at least partial alignment with and in close proximity to the permanent magnet 102 when the screen 14 is in the closed position such that the strike plate 116 and the permanent magnet 102 are in magnetic attraction to each other when the screen 14 is in the closed position to maintain the screen 14 in the closed position until the predetermined and selectable value of the stormwater force is exerted on the screen 14, the permanent magnet 102 and the strike plate 116 being spaced apart by a separation distance when the screen 14 is in at least one of the closed position and the open position. When the stormwater force exerted on the screen 14 no longer exceeds the predetermined and selectable value, the screen 14 will pivot under the overall weight thereof to the closed position.

In the third embodiment of the automatic retractable screen device 10 of the present invention described above, the screen 14 may include opposite lateral edges, and the automatic retractable screen device 10 may further comprise screen extension members 72, 74, each screen extension member 72, 74 being adjustably mounted on a respective opposite lateral edge of the screen 14 to extend outwardly from or adjust inwardly towards the respective opposite lateral edge of the screen 14 a desired distance in order to provide a combination of the screen 14 and the screen extension members 72, 74 with an adjustable overall width.

In the third embodiment of the automatic retractable screen device 10 of the present invention described above, the screen 14 may include a first screen section 14a and a second screen section 14b, the housing 42 being interposed between the first screen section 14a and the second screen section 14b.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. An automatic retractable screen device for use with a storm vault, the storm vault defining an interior cavity and having a side wall and a vault opening formed in the side wall, the vault opening allowing stormwater to flow therethrough and into the interior cavity of the storm vault, the automatic retractable screen device comprising:
a mounting assembly for mounting the automatic retractable screen device to the side wall of the storm vault and in close proximity to the vault opening;
a pivotable screen positionable to be in alignment with the vault opening of the storm vault when the automatic retractable screen device is mounted within the interior cavity of the storm vault;
structure affixed to the mounting assembly and the screen and configured to allow the screen to pivot on the mounting assembly between a closed position and an open position, the open position being different from the closed position; and
a magnetic release mechanism operatively coupled to the screen, wherein the magnetic release mechanism holds the screen in the closed position to block debris carried by the stormwater from entering the vault opening until a force of the stormwater exerted on the screen exceeds a predetermined value at which point the screen is released to pivot to the open position.

2. An automatic retractable screen device as defined by claim 1, wherein the mounting assembly includes a bracket configured to be affixable to the side wall of the storm vault.

3. An automatic retractable screen device as defined by claim 1, wherein the mounting assembly includes at least one support plate, the at least one support plate having a slot formed through the thickness thereof, and a fastener received by the slot and adjustably positionable along a length of the slot; and
wherein the structure configured to allow the screen to pivot between the closed position and the open position is operatively coupled to the fastener received by the slot and is adjustable in position relative to the at least one support plate so that the screen is adjustably positionable relative to the vault opening when the automatic retractable screen device is mounted within the interior cavity of the storm vault.

4. An automatic retractable screen device as defined by claim 1, wherein the magnetic release mechanism includes a permanent magnet, a strike plate having a structure which is magnetically attractable to the permanent magnet, and a bracket interconnecting the strike plate and the screen, the strike plate being disposed in at least partial alignment with and in close proximity to the permanent magnet when the screen is in the closed position, the permanent magnet and the strike plate being spaced apart by a separation distance when the screen is in at least one of the closed position and the open position.

5. An automatic retractable screen device as defined by claim 4, wherein the magnetic release mechanism includes structure for adjusting the separation distance between the permanent magnet and the strike plate.

6. An automatic retractable screen device as defined by claim 4, wherein the mounting assembly includes a mounting plate; and
wherein the magnetic release mechanism further includes an elongated member, the elongated member being adjustably mounted on the mounting plate, the elongated member having an axial end on which is mounted the permanent magnet, the axial end of the elongated member and the permanent magnet mounted thereon extending outwardly from the mounting plate an adjustable distance thereby causing the separation distance between the permanent magnet and the strike plate to be adjusted.

7. An automatic retractable screen device as defined by claim 1, wherein the screen includes opposite lateral edges; and
wherein the automatic retractable screen device further comprises screen extension members, each screen extension member being adjustably mounted on a respective opposite lateral edge of the screen to extend outwardly from or adjust inwardly towards the respective opposite lateral edge of the screen a desired distance in order to provide a combination of the screen and the screen extension members with an adjustable overall width.

8. An automatic retractable screen device for use with a storm vault, the storm vault defining an interior cavity and having a side wall and a vault opening formed in the side wall, the vault opening allowing stormwater to flow therethrough and into the interior cavity of the storm vault, the automatic retractable screen device comprising:
a bracket configured to be affixable to the side wall of the storm vault;
at least one support plate affixed to the bracket and extending therefrom, the at least one support plate having a slot formed through the thickness thereof, and a fastener received by the slot and adjustably positionable along a length of the slot;
a housing, the housing being mounted to the at least one support plate by the fastener and being adjustable on the at least one support plate by adjustment of the position of the fastener in the slot of the at least one support plate;
a pivotable screen positionable to be in alignment with the vault opening of the storm vault when the automatic retractable screen device is mounted within the interior cavity of the storm vault;
a pivot rod operatively coupled to the housing and the screen and configured to allow the screen to pivot on the housing between a closed position and an open position, the open position being different from the closed position; and
a magnetic release mechanism operatively coupled to the screen, wherein the magnetic release mechanism holds the screen in the closed position to block debris carried by the stormwater from entering the vault opening until a force of the stormwater exerted on the screen exceeds a predetermined value at which point the screen is released to pivot to the open position.

9. An automatic retractable screen device as defined by claim 8, wherein the housing defines an interior cavity;
wherein the magnetic release mechanism at least partially resides in the interior cavity of the housing;
wherein the housing includes a mounting plate disposed within the interior cavity thereof; and
wherein the magnetic release mechanism includes an elongated member mounted on the mounting plate, the elongated member having an axial end, a permanent magnet mounted on the axial end of the elongated member, a strike plate having a structure which is magnetically attractable to the permanent magnet, and a bracket interconnecting the strike plate and the screen, the strike plate being disposed in at least partial alignment with and in close proximity to the permanent magnet when the screen is in the closed position, the permanent magnet and the strike plate being spaced apart by a separation distance when the screen is in at least one of the closed position and the open position.

10. An automatic retractable screen device as defined by claim 9, wherein the elongated member is adjustably mounted on the mounting plate, the axial end of the elongated member and the permanent magnet mounted thereon extending outwardly from the mounting plate an adjustable distance thereby causing the separation distance between the permanent magnet and the strike plate to be adjusted.

11. An automatic retractable screen device as defined by claim 8, wherein the screen includes opposite lateral edges; and
wherein the automatic retractable screen device further comprises screen extension members, each screen extension member being adjustably mounted on a respective opposite lateral edge of the screen to extend outwardly from or adjust inwardly towards the respective opposite lateral edge of the screen a desired distance in order to provide a combination of the screen and the screen extension members with an adjustable overall width.

12. An automatic retractable screen device for use with a storm vault, the storm vault defining an interior cavity and having a side wall and a vault opening formed in the side wall, the vault opening allowing stormwater to flow therethrough and into the interior cavity of the storm vault, the automatic retractable screen device comprising:
a bracket configured to be affixable to the side wall of the storm vault;
at least one support plate affixed to the bracket and extending therefrom, the at least one support plate having a slot formed through the thickness thereof, and a fastener received by the slot and adjustably positionable along a length of the slot;
a housing defining an interior cavity, the housing being mounted to the at least one support plate by the fastener and being adjustable angularly on the at least one support plate and in relative position with respect to the at least one support plate by adjustment of the position of the fastener in the slot of the at least one support plate;
a pivotable screen positionable to be in alignment with the vault opening of the storm vault when the automatic retractable screen device is mounted within the interior cavity of the storm vault, the screen being adjustable in distance relative to the vault opening and in angular disposition relative thereto by adjustment of the housing on the at least one support plate when the automatic retractable screen device is mounted within the interior cavity of the storm vault, the screen having an overall weight;
a pivot rod operatively coupled to the housing and the screen and configured to allow the screen to pivot on the housing between a closed position and an open position, the open position being different from the closed position; and
a magnetic release mechanism operatively coupled to the screen and at least partially residing within the interior cavity of the housing, wherein the magnetic release mechanism holds the screen in the closed position to block debris carried by the stormwater from entering the vault opening until a force of the stormwater exerted on the screen exceeds a predetermined and selectable value at which point the screen is released to pivot to the open position;
wherein the housing includes a mounting plate disposed within the interior cavity thereof;
wherein the magnetic release mechanism includes an elongated member mounted on the mounting plate, the elongated member having an axial end, a permanent magnet mounted on the axial end of the elongated member, a strike plate having a structure which is magnetically attractable to the permanent magnet, and a bracket interconnecting the strike plate and the screen, the strike plate being disposed in at least partial alignment with and in close proximity to the permanent magnet when the screen is in the closed position such that the strike plate and the permanent magnet are in magnetic attraction to each other when the screen is in the closed position to maintain the screen in the closed position until the predetermined and selectable value of the stormwater force is exerted on the screen, the permanent magnet and the strike plate being spaced apart by a separation distance when the screen is in at least one of the closed position and the open position; and
wherein, when the stormwater force exerted on the screen no longer exceeds the predetermined and selectable value, the screen will pivot under the overall weight thereof to the closed position.

13. An automatic retractable screen device as defined by claim 12, wherein the screen includes opposite lateral edges; and
wherein the automatic retractable screen device further comprises screen extension members, each screen extension member being adjustably mounted on a respective opposite lateral edge of the screen to extend outwardly from or adjust inwardly towards the respective opposite lateral edge of the screen a desired distance in order to provide a combination of the screen and the screen extension members with an adjustable overall width.

14. An automatic retractable screen device as defined by claim 12, wherein the screen includes a first screen section and a second screen section, the housing being interposed between the first screen section and the second screen section.
